(19) United States
(12) Patent Application Publication
(10) Pub. No.: US 2022/0356887 A1
(43) Pub. Date: Nov. 10, 2022

(54) COOLING FAN

(71) Applicant: AMOTECH CO., LTD., Incheon (KR)

(72) Inventor: Byung Soo KIM, Anyang-si (KR)

(21) Appl. No.: 17/870,533

(22) Filed: Jul. 21, 2022

Related U.S. Application Data
(62) Division of application No. 16/652,215, filed on Mar. 30, 2020.

(30) Foreign Application Priority Data
Nov. 16, 2017 (KR) 10-2017-0153057

(51) Int. Cl. F04D 29/64; F04D 25/06; F04D 25/08; F04D 29/52; F04D 29/70

(52) U.S. Cl. CPC F04D 29/646; F04D 25/0606; F04D 25/08; F04D 29/522; F04D 29/703

(57) ABSTRACT

A cooling fan includes: a fan housing mounted on a mounting bracket; a rotary shaft rotatably supported by the fan housing; a rotor fixed to the rotary shaft; a stator fixed to the fan housing and disposed at a predetermined gap from the rotor; an impeller connected to the rotor so as to rotate therewith; and a separation prevention member formed in the mounting bracket so as to prevent the impeller from being separated from the fan housing. the separation prevention bar comprises: a pair of vertical bars formed at opposite edges of the air passage portion in a vertical direction to the mounting bracket and a horizontal bar connecting upper portions of the vertical bars, thereby providing a gap between the impeller and the horizontal bar so that the separation prevention bar does not interfere with rotation of the impeller.

### TECHNICAL FIELD

The present invention relates to a cooling fan for preventing overheating of electronic devices, automobiles, LED lights, and the like, and more particularly, to a cooling fan having an impeller separation prevention structure that can prevent an impeller from being separated.

### BACKGROUND ART

Cooling fans are mainly used to prevent overheating of various electronic devices, LED lights, or various components mounted in automobiles.

A cooling fan includes a rotary shaft rotatably supported in a fan housing, a rotor fixed to the rotary shaft, a stator fixed to the fan housing and disposed with a predetermined gap from the rotor, and an impeller fixed to the rotor and rotating with the rotor.

Here, the impeller may be separated from the fan housing during rotation of the impeller. Accordingly, an escape prevention ring is mounted on the lower side of the rotary shaft to prevent the impeller from being separated, and the escape prevention ring is caught in the fan housing to prevent the impeller from being separated.

That is, the battery cooling device disclosed in Korean Patent 10-1079050 (registered on Nov. 2, 2011) includes a rotary shaft which is rotatably supported by a pair of bearings, and a C ring which is mounted in a coupling groove formed at a lower side of the rotary shaft, thereby providing the rotary shaft from being separated.

In this way, in order to install the escape prevention ring on the rotary shaft to prevent the separation of the impeller, an opening should be formed on the lower surface of the housing, and the opening should be sealed with a cover after the escape prevention ring is mounted onto the rotary shaft through the opening of the housing. Accordingly, the number of parts increases and the assembly process is complicated.

### DISCLOSURE

### Technical Problem

It is an object of the present invention to provide a cooling fan in which a separation prevention member is mounted in a fan housing to prevent an impeller from being separated, thereby simplifying an assembly process of the cooling fan and preventing the separation of the impeller while minimizing the area blocking an air discharge port formed in the fan housing.

It is another object of the present invention to provide a cooling fan in which a separation prevention member is integrally formed to a mounting bracket on which the cooling fan is mounted, to thereby have no separate parts for preventing the separation of an impeller to thus reduce the number of parts and simplify an assembly process of the cooling fan.

### Technical Solution

A cooling fan according to an aspect of the present invention comprises: a fan housing mounted on a mounting bracket; a rotary shaft rotatably supported by the fan housing; a rotor fixed to the rotary shaft; a stator fixed to the fan housing and disposed at a predetermined gap from the rotor; an impeller connected to the rotor so as to rotate therewith; and a separation prevention member mounted at an edge on a front surface of the fan housing on which an air discharge port of the fan housing is formed, and protruding in an inward direction of the air discharge port so as to prevent the impeller from being separated from the fan housing.

The separation prevention member may include a fixing portion fixed to an edge of the fan housing, and a locking portion protruding inwardly of the air discharge port from the fixing portion to prevent separation of the impeller.

The separation prevention member may be disposed in a plurality of pieces at a 180-degree interval or a 90-degree interval on the edge of the fan housing and formed of a metal material.

The fan housing may have a fastening hole portion fastened to the mounting bracket at an edge thereof, and the fixing portion may have a through hole communicating with the fastening hole portion, and may be fixed to an edge of the fan housing.

A cooling fan according to another aspect of the present invention comprises: a fan housing mounted on a mounting bracket; a rotary shaft rotatably supported by the fan housing; a rotor fixed to the rotary shaft; a stator fixed to the fan housing and disposed at a predetermined gap from the rotor; and an impeller connected to the rotor so as to rotate therewith, wherein a separation prevention bar is formed in the mounting bracket so as to prevent the impeller from being separated from the fan housing.

The mounting bracket may have an air passage portion communicating with the air discharge port of the fan housing, and the separation prevention bar may be formed to extend inwardly from an edge of the air passage portion.

The separation prevention bar may include a pair of vertical bars formed in a vertical direction at one edge of the air passage portion so as to be spaced apart from each other so that the separation prevention bar does not interfere with the rotation of the impeller, and a horizontal bar connecting the pair of vertical bars.

### Advantageous Effects

As described above, the cooling fan according to the present invention may be formed so that a plurality of separation preventing members are mounted in the circumferential direction on the edge of the fan housing and protruded by a predetermined length in the inner direction of the air discharge port, thereby minimizing the area blocking the air discharge port and preventing the separation of the impeller.

In addition, the separation prevention member may be integrally formed to the mounting bracket on which the cooling fan is mounted, to thereby have no separate parts for preventing the separation of the impeller to thus reduce the number of parts and simplify an assembly process of the cooling fan.

### BRIEF DESCRIPTION OF THE DRAWINGS

FIG. 1 is an exploded perspective view of a cooling fan according to an embodiment of the present invention.

FIG. 2 is a perspective view of a cooling fan according to an embodiment of the present invention.

FIG. 3 is a cross-sectional view of a cooling fan according to an embodiment of the present invention.

FIG. 4 is a front view of a cooling fan according to an embodiment of the present invention.

FIG. 5 is a rear-side perspective view of a cooling fan according to an embodiment of the present invention.

FIG. 6 is a perspective view of a cooling fan according to another embodiment of the present invention.

FIG. 7 is a cross-sectional view of a cooling fan according to another embodiment of the present invention.

### BEST MODE

Hereinafter, embodiments of the present invention will be described in detail with reference to the accompanying drawings. The sizes and shapes of the components shown in the drawings may be exaggerated for clarity and convenience. In addition, terms defined in consideration of the configuration and operation of the present invention may vary depending on the intention or custom of the user, the operator, and the like. Definitions of these terms should be based on the content of this specification.

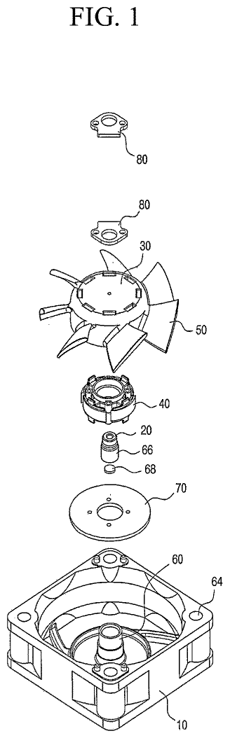

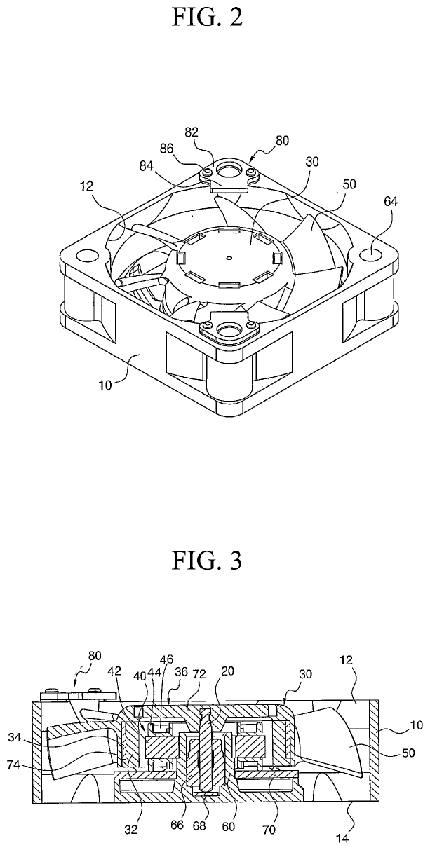

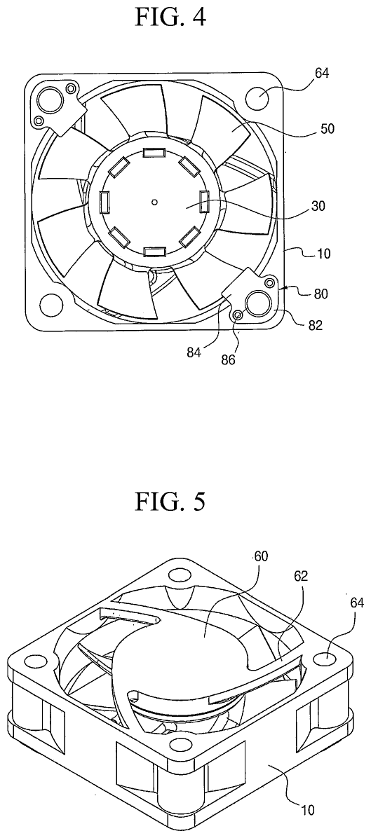

Referring to FIGS. 1 to 4, a cooling fan according to an aspect of the present invention includes: a fan housing 10 having an air discharge port 12 through which air is discharged therefrom and which is formed on the front surface thereof, and an air inlet 14 through which air flows thereinto and which is formed on the rear surface thereof; a rotary shaft 20 rotatably supported by the fan housing 10; a rotor 30 fixed to the rotary shaft 20; a stator 40 fixed to the fan housing 10 and disposed at a predetermined gap from the rotor 30; and an impeller 50 connected to the rotor 30 so as to rotate therewith.

The fan housing 10 has a front surface and a rear surface open to allow air to pass through, and a support portion 60 to which the stator 40 is fixed and which is formed in the center thereof while the rotary shaft 20 is rotatably supported in the center thereof.

The stator 40 includes a stator core 42 fixed to the outer circumferential surface of the support portion 60, a bobbin 44 mounted on the outer surface of the stator core 42, and a coil 46 wound around the bobbin 44 and through which electric power is applied.

A printed circuit board (PCB) 70 is mounted on the lower side of the stator 40, and the PCB 70 is equipped with various circuit components required for cooling fan control and a Hall sensor for measuring the number of revolutions of the rotor 30. The coil 46 of the stator 40 is electrically connected to a cable for external power connection.

The rotor 30 is disposed with a certain gap on the outer circumferential surface of the stator 40 and includes a magnet 32 formed in a cylindrical shape, a back yoke 34 disposed on the outer circumferential surface of the magnet 32, and a rotor support 36 to which the magnet 32 and the back yoke 34 are fixed and the impeller 50 is connected.

The rotor support 36 includes a disk portion 72 having a rotary shaft 20 connected to the center thereof and formed in a disk shape, and a cylindrical portion 74 vertically extending from the edge of the disk portion 72, and on the inner surface of which the magnet 32 and the back yoke 34 are fixed, and on the outer surface of which the impeller 50 is formed.

The impeller 50 is integrally formed with the rotor support 36 on the outer circumferential surface of the rotor support 36. That is, the impeller 50 and the rotor support 36 are formed by performing insert injection while the magnet 32, the back yoke 34, and the rotary shaft 20 are disposed in a mold, and the rotary shaft 20, the magnet 32 and the back yoke 34 are fixed on the rotor support 36.

Fastening holes 64 for fixing a mounting bracket on which a cooling fan is mounted are formed at the corners of the fan housing 10. The fastening holes 64 are formed to penetrate through the corners of the fan housing 10 and can be used to fix the cooling fan to the mounting bracket by bolt fastening, bonding, or fitting.

The support portion 60 is formed in a cylindrical shape in the center of the fan housing 10, and on the inner surface of which the rotary shaft 20 is rotatably inserted, and on the outer surface of which the stator 40 is fixed.

The fan housing 10 is integrally molded by a mold and made of a resin material. That is, as shown in FIG. 5, a connecting rib 62 and the supporting portion 60 are integrally formed with the fan housing 10 on the rear surface of the fan housing 10, and the lower surface of the supporting portion 60 is formed in a blocked state.

The rotary shaft 20 is rotatably supported by a sleeve bearing 66 on the inner surface of the support portion 60, and a bushing 68 is mounted on the bottom surface of the support portion 60 in which the lower end of the rotary shaft 20 is rotatably contacted on the bottom surface of the support portion 60.

In the cooling fan described above, the impeller 50 may be separated from the fan housing 10 when the impeller 50 is rotated because the rotary shaft 20 is vertically movably inserted into the support portion 60 and the sleeve bearing 66 is used.

In the present invention, a separation prevention unit is installed on any one of the fan housing and the mounting bracket to prevent separation of the impeller 50.

The separation prevention unit according to an embodiment is equipped with a separation prevention member 80 on the front edge where an air discharge port 12 of the fan housing 10 is formed to prevent separation of the impeller 50.

The separation preventing member 80 includes a fixing portion 82 fixed to a front edge at which the air discharge ort 12 of the fan housing 10 is formed, and a locking portion 84 protruding inwardly of the air discharge port 12 from the fixing portion 82 to block the rising of the impeller 50.

The fixing portion 82 includes the same through holes 86 as the fastening holes 64 formed at the corners of the fan housing 10, and is fixed to the fan housing 10 by bolts or rivets. Then, the locking portion 84 protrudes a predetermined length toward the inside of the air discharge port 12 of the fan housing 10 to prevent the impeller 50 from being separated from the fan housing 10.

The protruding length of the locking portion 84 prevents separation of the impeller 50 while minimizing the area blocking the air discharge port 12, thereby preventing separation of the impeller 50 without affecting the air discharge.

The separation prevention member 80 may be formed of a metal material having strong strength, and may be installed in a plurality of pieces at regular intervals in the circumferential direction of the fan housing 10. As an example, the separation prevention member 80 may be mounted in two pieces on the edge of the fan housing 10 at intervals of 180 degrees, and four pieces at intervals of 90 degrees.

As described above, the separation prevention member 80 is fixed to the edge of the fan housing 10 and is formed to protrude only a predetermined length in the inner direction of the air discharge port 12, thereby minimizing the area blocking the air discharge port 12 and preventing separation of the impeller 50.

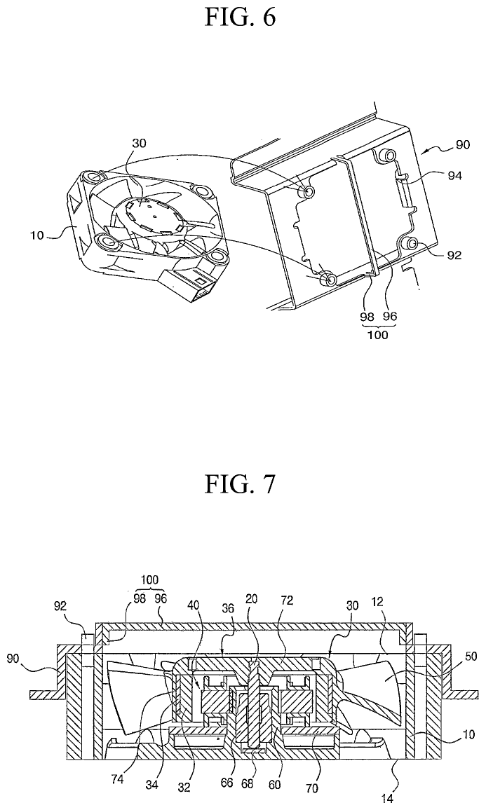

As shown in FIGS. 6 and 7, the separation prevention unit according to another embodiment includes a separation prevention bar 100 formed in a mounting bracket 90 on which a cooling fan is mounted. Accordingly, when the cooling fan is mounted on the mounting bracket 90, the impeller 50 can be prevented from being separated, so that a separation prevention structure for preventing the impeller from being separated from the cooling fan is unnecessary, thereby simplifying the structure and simplifying the assembly process.

The mounting bracket 90 communicates with the air discharge port 12 of the fan housing 10 to form an air passage portion 94 through which air passes, and a fastening protrusion 92 that is fastened to a fastening hole portion 64 formed in the fan housing 10 is formed at the edge of the mounting bracket 90.

The separation prevention bar 100 is formed to extend inwardly from the edge of the air passage portion 94 to prevent the impeller 50 from being separated from the fan housing 10.

The separation prevention bar 100 includes a pair of vertical bars 98 formed vertically at both edges of the air passage portion 94, and a horizontal bar 96 formed to connect between the pair of vertical bars 98 to prevent separation of the impeller 50.

When the cooling fan is mounted on the mounting bracket 90, the vertical bars 98 play a role of maintaining a certain gap between the impeller 50 and the horizontal bar 96 so that the horizontal bar 96 does not interfere with the rotation of the impeller 50.

As described above, the separation prevention unit according to another embodiment integrally forms the separation prevention bar 100 when forming the mounting bracket 90, and the cooling fan does not need a separate part for preventing separation of the impeller, so the number of parts can be reduced and the assembly process can be simplified.

While the present invention has been particularly shown and described with reference to exemplary embodiments thereof, by way of illustration and example only, it is clearly understood that the present invention is not to be construed as limiting the present invention, and various changes and modifications may be made by those skilled in the art within the protective scope of the invention without departing off the spirit of the present invention.

### INDUSTRIAL APPLICABILITY

The present invention can be usefully applied to cooling fans for preventing overheating of electronic devices, automobiles, LED lightings or the like.

What is claimed is:

1. A cooling fan comprising:
a mounting bracket having an air passage portion;
a fan housing mounted on the mounting bracket, the fan housing having a front surface and an air discharge portion formed in the front surface, wherein the mounting bracket is attached to the front surface of the fan housing for the air passage portion and the air discharge port to correspond to each other;
a rotary shaft rotatably supported by a support portion formed in a rear surface of the fan housing, the rear surface being opposite to the front surface;
a rotor fixed to the rotary shaft;
a stator fixed to the fan housing and disposed at a predetermined gap from the rotor;
an impeller connected to the rotor so as to rotate therewith; and
a separation prevention bar is formed in the mounting bracket so as to prevent the impeller from being separated from the fan housing,
wherein the separation prevention bar comprises: a pair of vertical bars formed at opposite edges of the air passage portion in a vertical direction to the mounting bracket and a horizontal bar connecting upper portions of the vertical bars, thereby providing a gap between the impeller and the horizontal bar so that the separation prevention bar does not interfere with rotation of the impeller.
